(19) United States
(12) Patent Application Publication
(10) Pub. No.: US 2026/0220012 A1
(43) Pub. Date: Jul. 30, 2026

(54) SERVER MAINTENANCE AND UPGRADE TOOL

(71) Applicant: FMR LLC, Boston, MA (US)

(72) Inventors: Sushant Sudhakar Shete, Holly Springs, NC (US); Sudeep Kumar Pramanick, Karnataka (IN)

(21) Appl. No.: 19/040,253

(22) Filed: Jan. 29, 2025

(51) Int. Cl. G06F 11/14

(52) U.S. Cl. CPC G06F 11/3409; G06F 2201/80; G06F 2201/84

(57) ABSTRACT

A computerized method is provided for automated server shutdown and restart for maintenance, efficiency, or upgrading. Systems and methods provided capture snapshots of critical parameters of both the database and operating system before shutdown and after restart. An ordered, step-by-step shutdown and restart process minimize errors and the captured snapshots can be automatically compared and a simplified report provided for evaluation to confirm successful maintenance, upgrade, and/or restart of the target server.

### TECHNICAL FIELD

This application relates generally to systems, methods, and apparatuses, including computer program products, for performing and validating server maintenance including in-place upgrades.

### BACKGROUND

Modern organizations run increasingly complicated distributed networks with thousands of database servers. Those database servers and the information therein and functions they perform are often critical to efficient operations. Unfortunately these servers occasionally require maintenance including substantive upgrades which are best performed in-place. Maintaining the integrity of the databases and their parameters and validation thereof post restart are important considerations but are heretofore underserved with present technology. Currently, manual actions and review is required eating up valuable resources and manpower and increasing overall costs.

For example, under current manual processes, users must manually identify and stop all active services one by one and there is considerable risk of failing to note all pre-shutdown active services and configuration settings, resulting in errors during restart. The complexity and expense of such shutdowns using current technology limits applications to required maintenance and can even cause delays in maintenance and upgrades that may otherwise benefit the organization.

### SUMMARY

Systems and methods of the invention provide an efficient tool for performing database server maintenance including in-place upgrades. The systems and methods herein can streamline maintenance and/or upgrades to Linux-based database servers (e.g., Red Hat Enterprise Linux™ (RHEL)) by automating several pre and post shutdown/maintenance/restart tasks and parameter snapshots and by performing a comprehensive comparison of pre/post restart snapshots and providing a detailed report while highlighting any issues. Accordingly, any function or operation requiring graceful shutdown and restart of a database server can be performed in a cost-effective and automated manner with reduced reliance on manual actions and review.

In various embodiments, the systems and methods described herein can record and compare both database and operating system parameters before and after shutdown and/or maintenance or upgrades as well as provide an extensive HTML report to users for review. This functionality overcomes the need with preexisting technologies for a user to run individual scripts for recording and comparing parameters and saves time by obviating the need for user authentication from host to host as the systems herein can use user input to perform all required validations.

In some embodiments, systems and methods can be divided into two categories: pre-shutdown and post-shutdown. Among the pre-shutdown activities, systems and methods can take a stock of the server before shutdown and maintenance or upgrade and gracefully shutdown all the services running on the server. Once the maintenance or upgrade is complete, the systems and methods herein can do the required processing to make the applications compatible with a new OS in case of an upgrade (such as Relinking or Recompiling). The systems and methods can then re-start the services which were shut down during the pre-shutdown step. As noted, systems and methods herein can then take stock of the server again, compare the PRE and POST states and send an email report to any required of effected users, teams, or administrators. Those individuals can view the report and validate the upgrade, even without logging on to the server. In case of issues, they can readily identify any highlighted problems from the report and resolve them as required.

In various embodiments, tools of the invention can be used wherever there is a need to shut down a Linux Server gracefully and then start it later. Pre-shutdown steps can be executed to stop all the services and post-shutdown steps can be executed to start them again and get a comparison report. Because the shutdown and restart of database servers is so streamlined using the disclosed systems and methods herein, it can become feasible to shut down resource intensive and therefore costly cloud-based Linux VM's on regular schedules (e.g., over weekends) or when not in high demand in order to save cost. Comparison reports can be used to validate that such periodic shutdown and start operations do not cause any issues.

Systems and methods of the invention can operate by taking a snapshot of important parameters systems such as the operating system (OS), Red Hat Package Manager (RPM), File System, Database (DB) and Services, Automatic Storage Management Cluster File Systems, CRON command-line utility, secure shell protocol (SSH) keys, and Commvault or other data protection systems. Backup of important configuration files, in case they are needed post upgrade can also be performed. All DB-related services can then be shut down before starting the maintenance or upgrade task and then re-started after the upgrade. An Oracle™ enterprise manager (OEM) blackout can be created and Crontab for oracle user can be disabled. The DB and automatic storage management (ASM) systems can then be stopped.

After upgrade of, for example, a Linux server, a post-upgrade script can be run, which can perform the above steps in the reverse order and then take a snapshot of the same important parameters again. In cases of system upgrades, systems and methods can then generate pre-and post-upgrade comparison reports for a user or team to use to validate the status of the upgrade without requiring that the user log on to the server, thereby increasing system efficiency and improving the operation of the computer system itself. Additionally, automation scripts can also be used as a tool, to validate DB server status for any other OS patching.

Aspects of the invention can include a computerized method for server maintenance with steps including preparing a server for maintenance, performing the server maintenance, completing post maintenance functions, comparing a pre-maintenance snapshot and a post-maintenance snapshot; and reporting status of the maintenance and results of the comparing step. Preparing the server for maintenance can include recording a pre-maintenance snapshot of selected operating system level parameters, selected storage level parameters, and selected database parameters; initiating a blackout of one or more monitoring tools monitoring the server; shutting down database services on the server; and shutting down a database on the server.

Completing post maintenance functions can include restarting the database; restarting the database services; disabling the blackout of the one or more monitoring tools; and recording a post-maintenance snapshot of the selected operating system level parameters, the selected storage level parameters, and the selected database parameters.

The operating system level parameters can comprise one or more of operating system parameters, kernel parameters, limit configuration parameters, an installed Red Hat Package Manager (RPM) list, and a secure shell protocol (SSH) public key list. The selected storage level parameters can comprise one or more of file system (FS) mounts, Automatic Storage Management Cluster File System (ACFS) mounts, ACFS disk groups, and ACFS volume groups. The selected database parameters can comprise one or more of Oracle listener parameters, database cluster ready services (CRS) parameters, database data guard parameters, and database services parameters.

In some embodiments, the snapshot can comprise scheduler parameters and system backup parameters. Scheduler parameters may include, for example, the list of jobs scheduled in the Cronjob. System backup parameters may include, for example, Commvault status where Commvault is used for Oracle Database Backup. Systems and methods can be used to record the Commvault status pre-and post-upgrade. The snapshot can further comprise operating system parameters, kernel parameters, limit configuration parameters, an installed RPM list, a secure shell protocol public key list, FS mounts, Automatic Storage Management Cluster File System (ACFS) mounts, ACFS disk groups, ACFS volume groups, Oracle listener parameters, database cluster ready services (CRS) parameters, database data guard parameters, and database services parameters. The one or more monitoring tools can comprise Oracle enterprise manager (OEM).

In some embodiments, the comparing step can comprise grouping snapshot data from the pre-maintenance snapshot and the post-maintenance snapshot by data type and converting the grouped snapshot data to key value pair representation for comparison. The database may be an Oracle database and completing post maintenance functions can further comprise relinking Oracle binaries before restarting the database. Methods can further comprise tracking execution of each step in the preparation of the server for maintenance; after shutting down the database services or shutting down the database, prohibiting restart of any step in the preparation of the server for maintenance until after the post maintenance functions are completed; and during completion of the post maintenance functions, only restarting services successfully shut down in the preparation of the server for maintenance. The server maintenance can comprise an operating system upgrade. In various embodiments, the database may be an Oracle Real Application Clusters (RAC) database and shutting down the database can further comprise: disabling Crontab; shutting down all instances of the Oracle database including shutting down all instances of related database services; stopping cluster ready services (CRS); and disabling CRS. In some embodiments, the database can be a standalone Oracle database and shutting down the database may further comprise: disabling Crontab; shutting down the Oracle database including stopping all database listeners; and emptying all oratab files. Methods can further comprise executing the preparing, performing, completing, comparing, and reporting steps on a plurality of servers in parallel.

Aspects of the invention can include computer systems for server maintenance. Systems can include a processor in communication with a non-transient memory and operable to perform the steps of preparing a server for maintenance, performing the server maintenance, completing post maintenance functions, comparing a pre-maintenance snapshot and a post-maintenance snapshot; and reporting status of the maintenance and results of the comparing step. Preparing the server for maintenance can include recording a pre-maintenance snapshot of selected operating system level parameters, selected storage level parameters, and selected database parameters; initiating a blackout of one or more monitoring tools monitoring the server; shutting down database services on the server; and shutting down a database on the server. Completing post maintenance functions can include restarting the database; restarting the database services; disabling the blackout of the one or more monitoring tools; and recording a post-maintenance snapshot of the selected operating system level parameters, the selected storage level parameters, and the selected database parameters.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for server shutdown, upgrade, and restart.

FIG. 2 shows an exemplary method for server maintenance.

FIG. 3 exemplary application architecture for systems and methods for upgrading a Linux-based database server.

FIG. 4 depicts an exemplary flow diagram of logic applied to identify mismatches in pre-and post-shutdown snapshots according to certain embodiments.

FIG. 5 depicts an exemplary flow diagram of logic applied to identify matches in pre-and post-shutdown snapshots according to certain embodiments.

### DETAILED DESCRIPTION

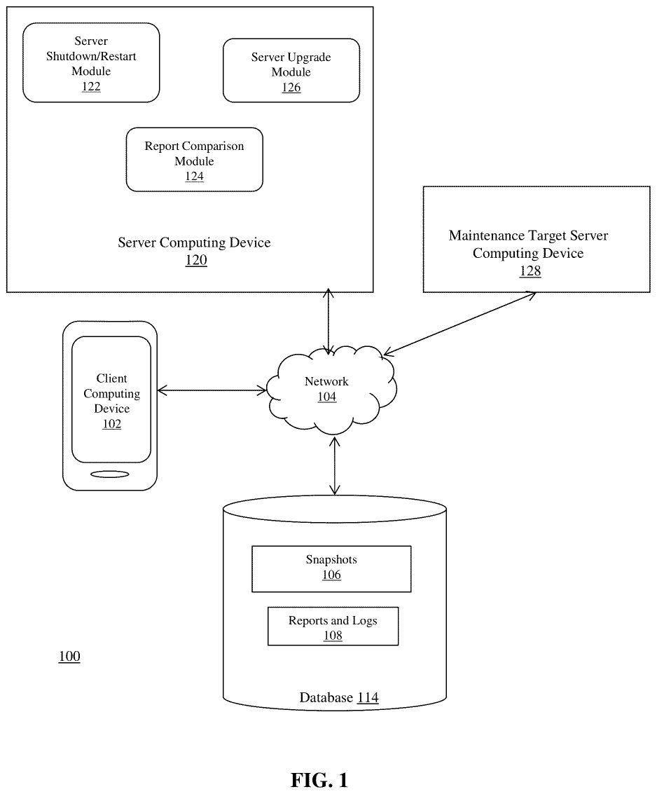

FIG. 1 is a block diagram of an exemplary system 100 for database server maintenance. The system 100 includes a client computing device 102, a communications network 104, a server computing device 120 that includes a Server Shutdown/Restart Module 122, a Report Comparison Module 124, and a Server Upgrade Module 126. The system 100 also includes a database 114 for storing snapshots (pre and/or post shutdown, maintenance, or upgrade) 106 and reports or logs for comparison 108. The modules for executing server shutdowns and restarts and logging and comparing parameters and reports may be present on a server computing device 120 that remains online, while performing the shutdown and restarting functions on one or more maintenance target server computing devices 128.

The client computing device 102 connects to one or more communications networks (e.g., network 104) in order to communicate with the server computing device 120 to provide input and receive output relating to the shutdown, upgrade, and/or restart processes. Administrators or other users may interact with the modules and/or reports or logs via a client computing device 102 through a user interface running on the server computing device 120 or the client computing device 102.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used in conjunction with applications or modules on the server computing device 120. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device 120) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the server computing device 120 and the database 114 in certain embodiments. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

The server computing device 120 is a device including specialized hardware and/or software modules that execute on a processor and interact with memory modules of the server computing device 120, to receive data from other components of the system 100, transmit data to other components of the system 100, and perform functions. As discussed above the server computing device 120 includes a Server Shutdown/Restart Module 122, a Report Comparison Module 124, and a Server Upgrade Module 126 along with any number of other programs that may execute on the processor of the server computing device 120 and may each, despite being disparate programs, rely on a regular exchange of data between them and/or the database 114. The Server Shutdown/Restart Module 122 can be responsible for coordinating the steps discussed below related to recording OS and DB parameters and completing the ordered steps of a shutdown and restart. The Report Comparison Module 124 can run the post-startup snapshot/report comparisons to identify any issues after maintenance or server upgrade. completion. The Server Upgrade Module 126, in cases where an upgrade is performed, may be proprietary software from the server OS or DB producer operable to perform any required maintenance or upgrade after the Server Shutdown/Restart Module 122 has completed shutdown. The Server Shutdown/Restart Module 122 may be operable to trigger the Server Upgrade Module 126 or other maintenance programs at the appropriate time after completion of shutdown procedures.

In some embodiments, the various modules, programs, or applications are specialized sets of computer software instructions programmed onto one or more dedicated processors in the server computing device 120 and can include specifically designated memory locations and/or registers for executing the specialized computer software instructions.

Although the applications and modules are shown in FIG. 1 as executing within the same server computing device 120, in some embodiments the functionality of the applications and modules can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the applications, programs, and/or modules is described in detail throughout this specification.

The database 114 is a computing device (or in some embodiments, a set of computing devices) coupled to the server computing device 120 and is configured to receive, generate, and store specific segments of data relating to server shutdown, maintenance, upgrade, and/or restart. In some embodiments, all or a portion of the database 114 can be integrated with the server computing device 120 or be located on a separate computing device or devices. The database 114 can comprise one or more databases configured to store portions of data used by the other components of the system 100, as will be described in greater detail below.

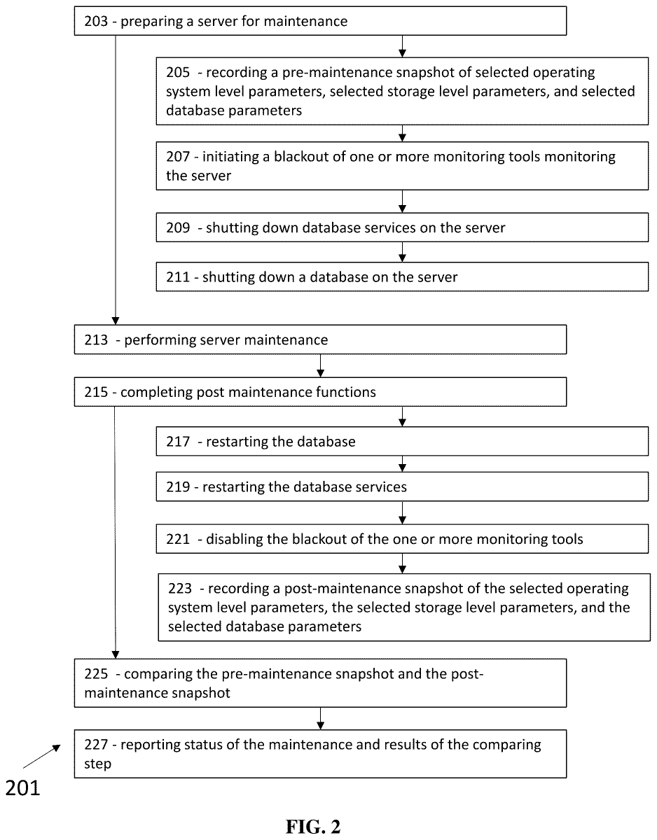

FIG. 2 shows an exemplary method 201 for server maintenance. Steps can include preparing 203 a server for maintenance, performing 213 the server maintenance, completing 215 post maintenance functions, comparing 225 a pre-maintenance snapshot and a post-maintenance snapshot; and reporting 227 status of the maintenance and results of the comparing step. Preparing 203 the server for maintenance can include recording 205 a pre-maintenance snapshot of selected operating system level parameters, selected storage level parameters, and selected database parameters; initiating 207 a blackout of one or more monitoring tools monitoring the server; shutting down 209 database services on the server; and shutting down 211 a database on the server.

Completing 215 post maintenance functions can include restarting 217 the database; restarting 219 the database services; disabling 221 the blackout of the one or more monitoring tools; and recording 223 a post-maintenance snapshot of the selected operating system level parameters, the selected storage level parameters, and the selected database parameters.

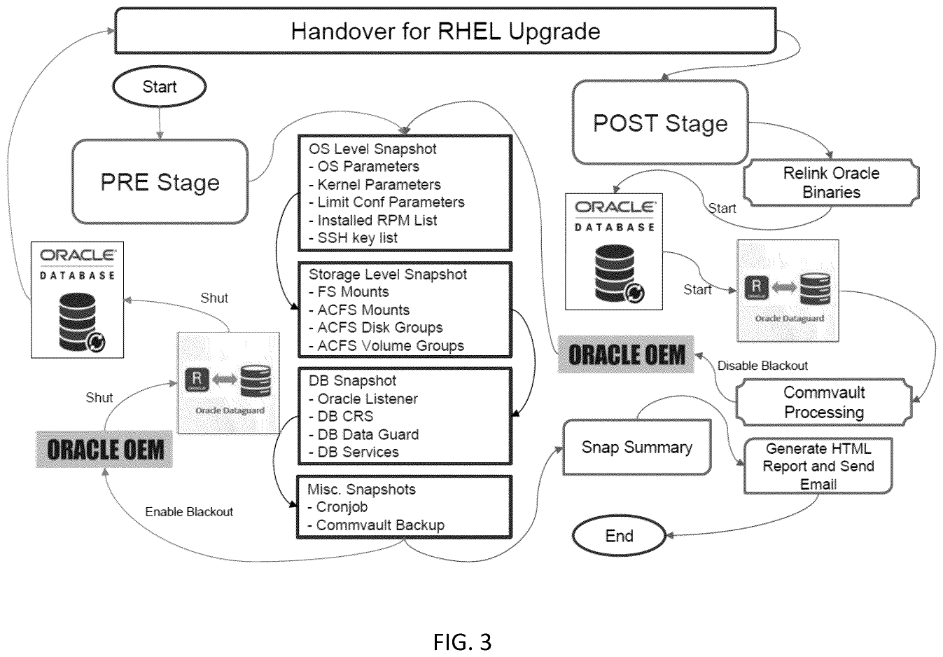

FIG. 3 illustrates an exemplary application architecture for systems and methods for upgrading a Linux-based database server. While the depicted architecture illustrates an Oracle database server undergoing a Red Hat Enterprise Linux (RHEL) OS upgrade, the principles can be applied to any server shutdown, restart, and verification processes. As part of the pre-shutdown stage, snapshots are taken at the OS level, the storage level, and of the DB, as well as various miscellaneous snapshots. The OS level snapshots can include OS Parameters, Kernel Parameters, Limit Conf Parameters, Installed RPM List, and SSH key list. The storage level parameters can include FS Mounts, ACFS Mounts, ACFS Disk Groups, and ACFS Volume Groups. The DB snapshots can include snapshots of parameters and/or features, status, or settings of Oracle Listener, DB CRS, DB Data Guard, and DB Services. Exemplary miscellaneous snapshots can be taken of Cronjob and Commvault Backup.

After recording the various snapshots, a blackout of Oracle OEM or other management programs can be initiated and Oracle Dataguard and/or any other programs or services that monitor, backup, or manage the database can be shut down followed by shutting down the database itself, in this case an Oracle Database. At this point the tool can handover the server for maintenance, in this case by triggering the OS upgrade for RHEL. Once the upgrade or other maintenance is completed or, if the shutdown was simply for cost savings or efficiency, on a trigger at a scheduled time, the post or startup stage can begin. Oracle Binaries can be relinked, the Oracle Database can be restarted followed by Oracle Dataguard. Commvault processing can then begin and the Oracle OEM blackout can be disabled with respect to the target server. At that point, the various snapshots discussed above can be taken again and compared to those taken before the shutdown. These snapshots as well as any issues or differences identified in the comparison can be flagged in a report along with the detailed snapshots themselves which can be stored for review of pushed to a user via e-mail of other notification service.

Systems and methods described herein can support parallel processing wherein several servers may be shut down, maintained, upgraded, and/or restarted at the same time. A locking mechanism can be employed once the shutdown process is initiated in various embodiments to avoid duplicate step executions. In such embodiments, only those services which were stopped during PRE stage will be started during POST stage. Accordingly, only the services stopped by the last PRE step execution will be started on subsequent POST stage executions. The systems and methods can track the process execution in a lock file in order to keep track of which PRE steps were completed when it comes time to initiate POST stage executions. Once a certain stage (e.g., stopping services) is passed, re-run of PRE steps may be restricted until the POST steps are executed.

Systems and methods may include logic to identify which differences to capture, and which ones to skip. A summary report can show the differences that are non-actionable with no special highlighting as opposed to actionable differences which may be flagged for follow-up.

The collected snapshot data may inherently be provided in various formats depending on the parameters being captured and the service or program from which they are captured. A tool may be provided to format the various snapshots and group them into files based on the type of data and/or by using appropriate Keys. The values of each Key can then be compared during PRE and POST stage to readily identify matches or differences. For example, all the data collected in various formats can be grouped in files and converted to Key Value Pairs. For efficient matching, the required parameters can then also be stored as Key Value Pair. The comparison tool can then sort the data and do the comparison while also removing any empty lines. For a quick preview, the comparison tool can provide the status of the execution in the email subject (e.g., successful upgrade, maintenance complete, upgrade failed, issues detected, or actions required). The tool can provide a summary of the server being upgraded, summary of the snapshot or parameter matches, warnings and errors in the email body. In the case of Linux-based Oracle database servers running the OEM monitoring tool, by enabling and disabling blackouts in OEM the system can avoid raising incidents as the DB goes down for the upgrade. In various embodiments, the modules, tools, or applications discussed herein may be created using Shell Scripting.

In some embodiments, shutdown and restart of the database may be specialized for either Oracle Real Application Clusters (RAC) or standalone databases. For RAC databases, the ordered processes can include OEM Blackout: So that OEM does not start creating Incidents if the DB or Server goes down; Disable Crontab: So that Cronjobs are not fired during the OS Upgrade; Shutdown the Data Guard: So that other servers are not impacted. Loop through all the DB Instances and Shut them down which will in turn shut the Listeners and other DB Services; Stop CRS: It will stop the Cluster Related Services; and Disable CRS: So that CRS does not start running automatically upon Server Reboot.

For a standalone database, the ordered processes can include OEM Blackout: So that OEM does not start creating Incidents if the DB or Server goes down; Disable Crontab: So that Cronjobs are not fired during the OS Upgrade; Shutdown the Data Guard: So that other servers are not impacted; Loop through all the running DB's and shut them down; Loop through all the Listeners and Stop them; and Empty/etc/oratab and /<VAH>/oracle/etc/oratab file so that they are not Started automatically on Server Reboot. During server startup with either RAC or standalone databases, the above DB services are started in the reverse order.

Exemplary pre and post snapshot, parameter, or report comparisons can include the following parameters: HugePages: HugePages optimizes the memory configuration of the Linux operating system. Oracle uses specific Hugepages size to work optimally, ideally 2MB; Mount Points: Captures all Mount Point names; Cron Jobs: Captures all the cronjobs before and after, as missing cronjobs can cause issues; CRS (Cluster Ready Services): Captures all CRS services before and after the upgrade to make sure that all the services are up; DB Services: Captures the DB related services so that users can be alerted if some services don't come up.

As noted, PRE and POST snapshot data can be collected in a Key Value pair, so that they can be compared easily. Some may be static keys like “IPCONFIG” while some may be dynamically created. Parameters for “Firewall”, may have two different types, such as “Loaded” and “Active”. Accordingly, keys like “Firewall Loaded” and “Firewall Active” may be created so that correct values are grouped together and compared correctly.

For standalone servers, systems and methods of the invention may clear/etc/oratab and /<VAH>/oracle/etc/oratab files in the PRE step so that the database does not start automatically after server reboot. These files can then be restored during the POST step at the appropriate time. After a RHEL OS upgrade, some parameters may not show up in OEM. Accordingly, in some embodiments, during the POST stage the OEM Agent home location from the file/etc/oragchomelist may be obtained followed by execution of “clearstate agent” and “upload agent” commands to refresh OEM. Servers connected by Data-guard services can be processed to minimize interference with other servers.

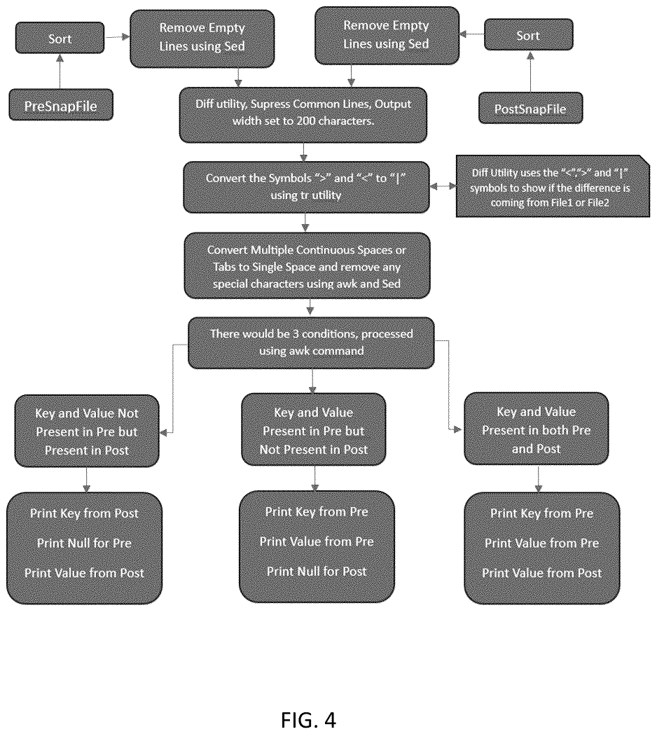

FIG. 4 depicts an exemplary flow diagram of logic applied to identify mismatches in pre-and post-shutdown snapshots according to certain embodiments. The snapshots taken before the shutdown and after the restart are compiled in a PreSnapFile and a PostSnapFile, respectively. Those files can be independently sorted and any empty lines can be removed using Sed. A Diff utility can be used to suppress common lines and provide a uniform output width (e.g., 200 characters). A tr utility can be used to convert <and >symbols to |. The Diff utility uses the <, >, and | symbols to show if the difference is coming from the first file or second file. Multiple continuous spaces can be converted so a single space and special characters can be removed using awk and Sed. Three exemplary conditions processed using the awk command are illustrated in FIG. 4.

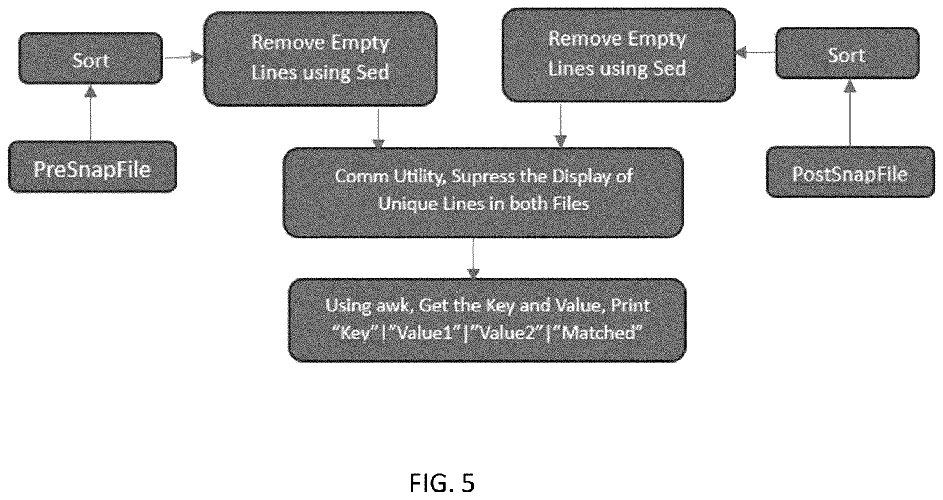

FIG. 5 depicts an exemplary flow diagram of logic applied to identify matches in pre-and post-shutdown snapshots according to certain embodiments. As above, the PreSnapFile and PostSnapFile are each sorted and any empty lines are removed using Sed. A Comm Utility can then be used to suppress the display of unique lines in both files. Awk can then be used to obtain Key and Value and Print “Key”|“Value1”|“Value2”|“Matched”.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for server maintenance, the method comprising:
preparing a server for maintenance by:
recording a pre-maintenance snapshot of selected operating system level parameters, selected storage level parameters, and selected database parameters;
initiating a blackout of one or more monitoring tools monitoring the server;
shutting down database services on the server;
shutting down a database on the server;
performing server maintenance;
completing post maintenance functions comprising:
restarting the database;
restarting the database services;
disabling the blackout of the one or more monitoring tools; and
recording a post-maintenance snapshot of the selected operating system level parameters, the selected storage level parameters, and the selected database parameters;
comparing the pre-maintenance snapshot and the post-maintenance snapshot; and
reporting status of the maintenance and results of the comparing step.

2. The method of claim 1, wherein the operating system level parameters comprise one or more of operating system parameters, kernel parameters, limit configuration parameters, an installed Red Hat Package Manager (RPM) list, and a secure shell protocol (SSH) public key list.

3. The method of claim 1, wherein the selected storage level parameters comprise one or more of file system (FS) mounts, Automatic Storage Management Cluster File System (ACFS) mounts, ACFS disk groups, and ACFS volume groups.

4. The method of claim 1, wherein the selected database parameters comprise one or more of Oracle listener parameters, database cluster ready services (CRS) parameters, database data guard parameters, and database services parameters.

5. The method of claim 1, wherein the snapshot comprises scheduler parameters and system backup parameters.

6. The method of claim 5, wherein the snapshot further comprises operating system parameters, kernel parameters, limit configuration parameters, an installed RPM list, a secure shell protocol public key list, FS mounts, Automatic Storage Management Cluster File System (ACFS) mounts, ACFS disk groups, ACFS volume groups, Oracle listener parameters, database cluster ready services (CRS) parameters, database data guard parameters, and database services parameters.

7. The method of claim 1, wherein the one or more monitoring tools comprise Oracle enterprise manager (OEM).

8. The method of claim 1, wherein the comparing step comprises grouping snapshot data from the pre-maintenance snapshot and the post-maintenance snapshot by data type and converting the grouped snapshot data to key value pair representation for comparison.

9. The method of claim 1, wherein the database is an Oracle database and completing post maintenance functions further comprises relinking Oracle binaries before restarting the database.

10. The method of claim1, further comprising tracking execution of each step in the preparation of the server for maintenance;
after shutting down the database services or shutting down the database, prohibiting restart of any step in the preparation of the server for maintenance until after the post maintenance functions are completed; and
during completion of the post maintenance functions, only restarting services successfully shut down in the preparation of the server for maintenance.

11. The method of claim 1, wherein the server maintenance comprises an operating system upgrade.

12. The method of claim 7, wherein the database is an Oracle Real Application Clusters (RAC) database and shutting down the database further comprises:
disabling Crontab;
shutting down all instances of the Oracle database including shutting down all instances of related database services;
stopping cluster ready services (CRS); and
disabling CRS.

13. The method of claim 7, wherein the database is a standalone Oracle database and shutting down the database further comprises:
disabling Crontab;
shutting down the Oracle database including stopping all database listeners; and
emptying all oratab files.

14. The method of claim 1, further comprising executing the preparing, performing, completing, comparing, and reporting steps on a plurality of servers in parallel.

15. A computer system for server maintenance, the system comprising a processor in communication with a non-transient memory and operable to perform the steps of:
preparing a server for maintenance by:
recording a pre-maintenance snapshot of selected operating system level parameters, selected storage level parameters, and selected database parameters;
initiating a blackout of one or more monitoring tools monitoring the server;
shutting down database services on the server;
shutting down a database on the server;
performing server maintenance;
completing post maintenance functions comprising:
restarting the database;
restarting the database services;
disabling the blackout of the one or more monitoring tools; and
recording a post-maintenance snapshot of the selected operating system level parameters, the selected storage level parameters, and the selected database parameters;
comparing the pre-maintenance snapshot and the post-maintenance snapshot; and
reporting status of the maintenance and results of the comparing step.

16. The system of claim 15, wherein the operating system level parameters comprise one or more of operating system parameters, kernel parameters, limit configuration parameters, an installed Red Hat Package Manager (RPM) list, and a secure shell protocol (SSH) public key list.

17. The system of claim 15, wherein the selected storage level parameters comprise one or more of file system (FS) mounts, Automatic Storage Management Cluster File System (ACFS) mounts, ACFS disk groups, and ACFS volume groups.

18. The system of claim 15, wherein the selected database parameters comprise one or more of Oracle listener parameters, database cluster ready services (CRS) parameters, database data guard parameters, and database services parameters.

19. The system of claim 15, wherein the snapshot comprises scheduler parameters and system backup parameters.

20. The system of claim 15, wherein the comparing step comprises grouping snapshot data from the pre-maintenance snapshot and the post-maintenance snapshot by data type and converting the grouped snapshot data to key value pair representation for comparison.
